(19) United States
(12) Patent Application Publication
(10) Pub. No.: US 2013/0182464 A1
(43) Pub. Date: Jul. 18, 2013

(54) DC Converter With Low Starting Voltage

(71) Applicant: Albert-Ludwigs-Universitat Freiburg, Freiburg (DE)

(72) Inventor: Peter Woias, Freiburg (DE)

(73) Assignee: ALBERT-LUDWIGS-UNIVERSITAT FREIBURG, Freiburg (DE)

(21) Appl. No.: 13/721,282

(22) Filed: Dec. 20, 2012

(30) Foreign Application Priority Data
Dec. 23, 2011 (DE) 102011122197.6

(51) Int. Cl. H02M 3/335

(52) U.S. Cl. CPC H02M 3/33507
USPC 363/21.17

(57) ABSTRACT

The present invention relates to an electronic circuit with which input voltages at an input of the circuit are converted into higher output voltages at an output of the circuit, whereby the voltage conversion already starts at low voltages at the input. According to the present invention, the DC converter circuit for the generation of an output voltage from an input voltage (Vᵢₙ) comprises a transformer (Tr) with a first primary winding (1) that can be connected to the input voltage (Vᵢₙ) via a first transistor (T₁) that is connected in series, and a second primary winding (2) that can be connected to the input voltage (Vᵢₙ) via a second transistor (T₂) that is connected in series. The transformer (Tr) furthermore has at least one secondary winding (3, 4) that has a higher number of windings than the first and the second primary winding (1, 2) and that is connected to control inputs of the first and second transistor (T1, T2), as well as to an output terminal of the DC converter circuit for the output of the output voltage (Vₒᵤₜ).

The present invention relates to an electronic circuit with which low input voltages at an input of the circuit are converted into higher output voltages at an output of the circuit. The circuit here is supplied with electrical energy for its own operation from its input. It is furthermore designed such that the voltage conversion already starts at low electrical voltages at its input. Excesses in energy from voltage potentials that are generated in the interior of the circuit in order to control the conversion internally are moreover conducted to the output in order in this way to achieve maximum efficiency of the voltage conversion.

Energy harvesting is a technique with which microsystems are supplied with energy from their respective environment and at their respective place of use. For this purpose, electrical energy is obtained from another energy form present at the place of use, for example, from thermal, mechanical or optical energy or from chemical bond energy. For this purpose, a very wide range of generators is in development or in use, such as, e.g., thermoelectric generators, mechanoelectrical generators, photovoltaic generators or fuel cells.

Various known generators supply electrical output voltages that are significantly less than the voltage level that is required for the operation of the electronics of an embedded microsystem, Furthermore, the output voltage of various generators depends on the level of the fed input energy. If the energy feed varies, the output voltage of the generator is correspondingly variable.

Known examples of generators of this kind are thermoelectric generators, which have an electrical series circuit of thermocouples, each of two different materials. These thermocouples are arranged between two, normally ceramic, assembly plates in a temperature gradient in such a way that each assembly plate, and thereby one side of the thermocouple, is subjected to a higher temperature than the other assembly plate or side of the thermocouple.

The known functional principle of this generator is based on the Seebeck Effect. The output voltage of a thermogenerator, without a load on the generator, is calculated according to the following equation (1):

V=n·S·ΔT

where n is the number of thermocouples of the generator, S is the Seebeck coefficient of a thermocouple and ΔT is the difference between the temperature of the upper of the thermocouples and the bottom side of the same.

An increase in the output voltage is possible by means of increasing the number n of thermocouples. Because thermogenerators are, however, frequently manufactured by means of the mechanical assembly of thermocouples, the useful increase of n has an upper limit with this manufacturing technology. In addition, this increases the construction size of the generator. Likewise, as the number n increases, the internal electrical resistance of the generator also increases, as consequently does the inner loss under load. At low temperature gradients, which are present in many applications, such generators consequently deliver only low output voltages, e.g., in the range of a few mV, which cannot be used meaningfully, in order to supply an electronic circuit with energy.

It is possible to manufacture thermogenerators in microtechnical construction with a significantly higher number of thermocouples, and corresponding systems are being both examined scientifically and also offered commercially. In this case, however, the cross-sectional area of the thermocouplers drops, and consequently their internal resistance increases and therefore the internal resistance of the entire generator increases. Although there is a higher open-circuit voltage available, this drops significantly more strongly under load due to the greater internal resistance.

Photovoltaic cells are a further example of a generator with comparably low output voltage. In silicon technology, photovoltaic cells deliver typical output voltages of 0.5 V per cell without a load at the output. Under load, this voltage level drops further, due to the internal resistance of the generator. This voltage level is, on the other hand, too low to operate electronics according to today's state of the art. Moreover, the output voltage of photovoltaic generators also drops as the incident light power drops. In principle, a plurality of photovoltaic cells can be connected in series electrically in order to increase the output voltage of the series circuit. As a result, the necessary area increases at the same time, however, and likewise individual cells can be subjected to different radiation levels due to local shadowing. As a result, the output power of the entire generator arrangement drops in turn.

In the two generators mentioned, but also in other comparable cases, it is necessary to increase, with a circuit for voltage conversion, the low output voltage of the generator to such a point that an electronic circuit can be supplied with sufficiently high voltage, as is shown in FIG. 1. For this purpose, an electronic DC converter is arranged between the generator and the electronics which in the following is called the load resistor R_{L}. The output of the generator is connected to the input of the DC converter and the output of the DC converter is connecter to the load. As a result, the variable input voltage Vᵢₙ, which is provided by the generator, is applied at the input of the DC converter. In the DC converter, Vᵢₙ is transformed into a higher output voltage Vₒᵤₜ, which is applied at the load R_{L}.

The electronic system at the output of the DC converter can additionally contain an electrical energy storage device, e.g., a rechargeable battery or an electrical capacitor. In this case, the DC converter feeds the energy storage device and the load via its output. If the input energy at the generator drops to a level that is too low still to drive the electronics of the DC converter reliably, energy from the energy storage device is available in order to ensure continuously the operation of the DC converter as needed by feeding from the output or via a separate feed entry. This would likewise ensure that the converter circuit is functional again immediately and starts up when there is again sufficient input energy available from the generator. If, however, this temporary storage is not available or has been discharged excessively, then it is necessary for the DC converter to draw its operating energy completely from its input and already take on the function at the lowest possible input voltages. This is essential content of the present invention.

Known from today's state of the art are various circuit concepts with which low input voltages can be transformed into higher output voltages.

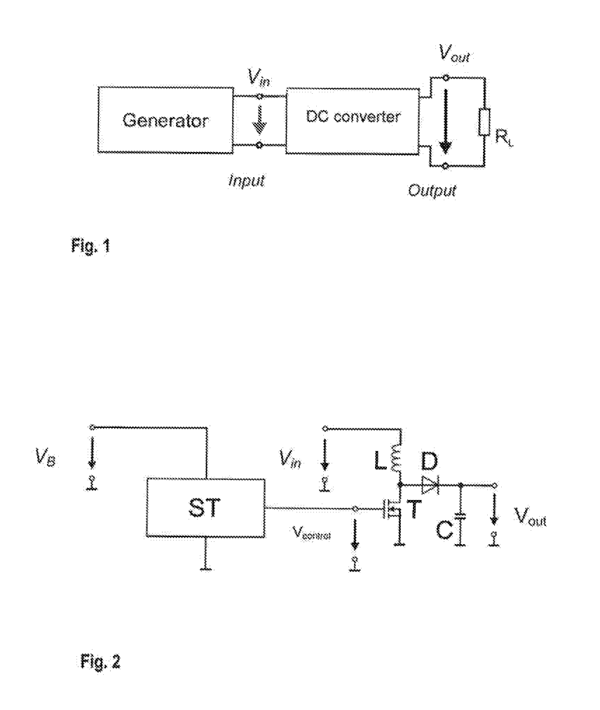

One concept that is used frequently is the so-called inductive step-up converter, which is available as an integrated circuit in numerous embodiments. A description can be found in U. Tietze, Ch. Schenk, “Halbleiter-Schaltungstechnik”, Springer-Verlag, 11th Edition, 1999, page 985 and following. The basic circuit, which is reproduced in FIG. 2, comprises a switching transistor in bipolar or MOS technology, an inductor, a diode and a capacitor. A control circuit ST for the generation of square wave signals V_{control} is furthermore required, which is supplied from an operating voltage V_{B}.

Transistor T is switched on and switched off in alternation with the help of a square wave control voltage V_{control}. In the switch-on phase, a current flows from the input voltage Vᵢₙ through the coil L and the conductive transistor T to earth. This current first increases linearly through the inductor L, while at the same time a magnetic field is built up in the coil. After the transistor is switched off, the inductor L attempts to maintain the current flow in the original direction, in accordance with the known Lenz's Law. The result is a volatile increase in the electrical voltage at the junction between diode D, inductor L and the drain terminal of transistor T, in such a way that diode D is polarised in the direction of flow. As a result, there follows a continuation of the current flow through the inductor L to capacitor C via diode D and at the same time, an increase in the input voltage level Vᵢₙ to a higher voltage level Vₒᵤₜ at the output. The current flow subsides as soon as the magnetic field in the coil has broken down and the voltage at the junction no longer lies above the sum of the diode flow voltage and the output voltage.

The control circuit ST requires an operating voltage V_{B} for the generation of square wave signals with sufficient amplitude. This represents a serious problem for step-up converters that are to be supplied from a low input voltage Vᵢₙ. The starting voltage, i.e., the minimum required input voltage, is substantially determined by the required operating voltage of the control circuit and the required amplitude of the control voltage V_{control} and cannot be reduced at will. In various circuit concepts, auxiliary circuits are used for the support of the starting phase at low voltages. For such an example circuit, the TPS 61200 integrated circuit from the manufacturer Texas Instruments, the minimally required input voltage Vᵢₙ nevertheless still amounts to roughly 0.3 V without a load at the output Vₒᵤₜ and roughly 0.5 V if the output is loaded.

In the case of the step-up converter, the magnetic field in the core of the coil always oscillates around a mean value that is correlated to the mean value of the coil current. This leads to the coil core always remaining pre-magnetised in one direction. Due to this fact, the design of the coil core must ensure that even in the event that the magnetic field is oscillating around a mean value, lossy saturation of the core does not occur. This leads, for example, to the fact that the core must be designed such that it is correspondingly larger.

An alternative concept according to the state of the art is the so-called forward converter, which operates a transformer by means of suitable wiring in such a manner that the magnetic field is held to zero on average. This configuration consequently avoids the disadvantage of pre-magnetisation that is present with the step-up converter.

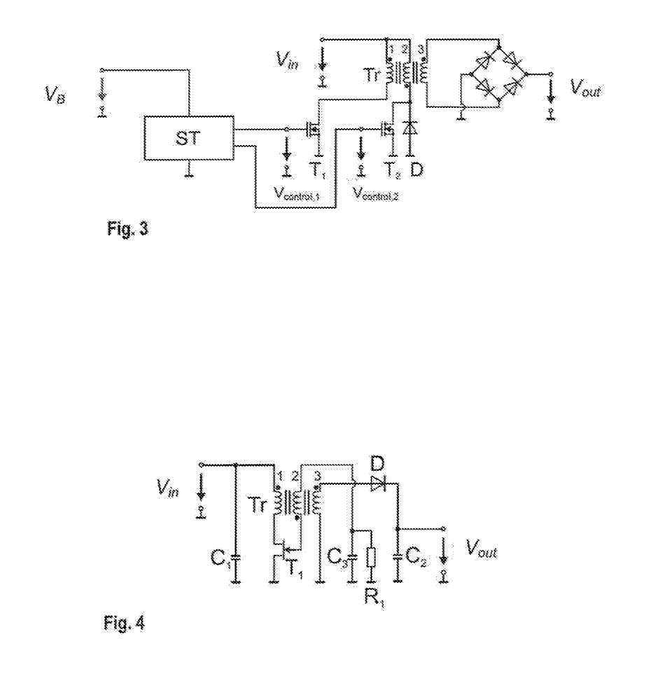

FIG. 3 shows a corresponding basic circuit of a single-ended forward converter according to the state of the art.

A transformer with three windings is operated in this circuit. In the depicted example, winding 3 provides the output voltage Vₒᵤₜ via a full-wave rectifier of four diodes. Winding 1 is applied to and separated again from the input voltage Vᵢₙ in alternation via transistor T₁. Winding 2 is connected between the input voltage Vᵢₙ and earth via a diode D. As in winding 3, an induced alternating voltage arises in winding 2. This alternating voltage is always short-circuited when a negative voltage is induced on the cathode of diode D. With a suitable selection of the winding senses of winding 1 and 2, this is then always the case when transistor T₁ blocks. The corresponding current flow through winding 2 and D leads to the magnetic field in the coil core reversing its polarity due to a demagnetising flow running in the opposite direction with respect to winding 1. Likewise, energy is fed back to the input voltage Vᵢₙ via the current flowing in winding 2. On average and in the ideal case, the resulting magnetising equals zero, with the advantage that a more compact design can be selected for the core of the transformer, and the risk of saturation of the core can be avoided.

According to the state of the art, such as described, for example, in the monograph of U. Tietze, Ch. Schenk, “Halbleiter-Schaltungstechnik”, Springer-Verlag, 11th edition, 1999, page 990, only one diode D is used, i.e., transistor T₂ shown in FIG. 3 is, e.g., not mentioned there.

It is, however, possible to use, in addition to diode D, an actively controlled transistor T₂ which is connected in parallel to diode D, as is shown schematically in FIG. 3. As an advantage, a smaller voltage drop occurs across diode D, and consequently there is a reduction in the electrical losses in the diode. T₂ must accordingly be switched on and switched off in alternation with transistor T₁.

In any case, a control circuit ST is again required for this converter, whereby this control circuit generates the corresponding square wave signals V_{control,1} and V_{control,2} and applies them to the gate terminals of one or both transistors. As a result, in the case of this circuit concept, the same problems arise as in the previously described step-up converter. If the entire circuit is to be operated from the input voltage Vᵢₙ, then the required operating voltage V_{B} of the control circuit ST defines the minimum possible starting voltage.

A resonant switching converter principle on the basis of a modified Meissner oscillator is presented in the article “IEEE TRANSACTIONS ON INDUSTRY APPLICATIONS”, VOL. 33, NO. 5, SEPTEMBER/OCTOBER, 1997. The corresponding assembly is called a “starter circuit” in the publication and is depicted in FIG. 4.

In the case of this known circuit, the drain-source path of an n-channel junction field-effect transistor T₁ (n-JFET) is connected in series to the winding 1 of a transformer Tr and subjected to electrical voltage via the input Vᵢₙ of the converter circuit. A winding 2 of the transformer Tr with a substantially higher number of windings than the winding 1 is interconnected to the gate of the n-JFET T₁ as feedback. This is done with a winding in the sense opposite to that of the primary winding. As a result, a positive voltage at winding 1 generates a negative voltage at winding 2 and vice versa. The reference point of winding 2 is connected to the reference earth of the circuit via a parallel circuit with a capacitor C₃ and a resistor R₁, while the high point is connected to the gate of the n-JFET T₁.

This circuit was developed for starting voltages Vᵢₙ of roughly 300 mV. It utilises the fact that an n-JFET is already conductive at a gate-source voltage of 0 V. Consequently, at low input voltages, a current flow already starts through winding 1 of the transformer Tr and through the n-JFET T₁ and a positive voltage arises at winding 1. The magnetic field that develops induces a negative voltage in the feedback winding 2 of the transformer, which, depending on the winding relationship between the two windings, is greater than the voltage at the primary winding 1. The gate-source path of the n-JFET T₁ constitutes a pn-diode, whereby the anode lies at the gate. This diode limits the voltage V_{GS} at the gate of T₁ to roughly +0.6 V to earth. As a result, the higher transformed voltage at winding 2 charges the capacitor of the RC element of C₃ and R₁ to negative voltages V_{RC} with respect to earth.

As soon as the current flow through winding 1 reaches a state of equilibrium, the voltage induced in winding 2 breaks down. As a result, the negative potential V_{RC} built up at capacitor C₃ penetrates through the gate of the n-JFET T₁ and polarises the pn-transition in the reverse direction. The more this negative gate voltage approaches the negative terminal voltage of the n-JFET, the more transistor T₁ is blocked. The resulting drop in the current in winding 1 induces a positive voltage in winding 2. This positive voltage at winding 2 is added in reversed polarity to the already existing negative gate bias. As a consequence, V_{GS} further changes in the direction of negative values until transistor T₁ is blocked abruptly at a certain point in time. The RC element of C₃ and R₁ now discharges at its RC time constant, as a result of which the gate-source voltage V_{GS} at transistor T₁ is changed from negative values back toward 0 volts with this time delay. As a consequence, the current flow through winding 1 gradually increases again, because T₁ again becomes conductive. The described process repeats.

In a winding 3 of the transformer, this self-controlled oscillation induces a further alternating voltage which, due to the higher winding ratio, lies above the input voltage at winding 1 by an adjustable factor. This voltage is rectified with a diode D and used as a stepped-up output voltage. The capacitors C₁ and C₂ buffer the voltages Vᵢₙ and Vₒᵤₜ, respectively.

In the published international application WO 2009/138180 A1 as well as the publication “STEP-UP DC-DC-CONVERTER WITH COUPLED INDUCTOR FOR LOW INPUT VOLTAGES”, Proceedings of PowerMEMS 2008+microEMS 2008, Sendai, Japan, Nov. 9-12, 2008, pp. 145-148, the same concept of a Meissner oscillator is used.

Unlike the circuit from the article “IEEE TRANSACTIONS ON INDUSTRY APPLICATIONS”, VOL. 33, NO. 5, SEPTEMBER/OCTOBER 1997, an n-channel MOSFET (NMOS) with a low channel resistance is connected in parallel to the n-JFET. The gate terminal of the NMOS is connected capacitively to the high point of the winding 2 via an assembly called the “regulation loop”, while the gate of the n-JFET, as shown in “IEEE TRANSACTIONS ON INDUSTRY APPLICATIONS”, VOL. 33, NO. 5, SEPTEMBER/OCTOBER 1997, is connected to the high point of winding 2 of the transformer. Furthermore, an RC element is inserted between the base point of winding 2 and the circuit earth.

The combination of NMOS and winding 1 forms the basic circuit of a step-up converter, while the combination of n-JFET and transformer constitutes a Meissner oscillator. The output voltage of the converter is acquired from the step-up converter by means of a diode rectifier. Winding 2 consequently is used only for the generation of the transistor control signals and not for voltage conversion at the output.

After the input voltage is switched on, the Meissner oscillator first generates an increased alternating voltage in winding 2 according to the functional principle described in “IEEE TRANSACTIONS ON INDUSTRY APPLICATIONS”, VOL. 33, NO. 5, SEPTEMBER/OCTOBER 1997. As soon as the alternating voltage induced in winding 2 is large enough, a periodic switching on and switching off of the NMOS transistor takes place by means of the feedback of the alternating voltage from winding 2 and the gate trigger circuit. In this way, the voltage at the RC element of winding 2 is increased to continuously negative values, whereupon the n-JFET is permanently switched off according to information provided in “STEP-UP DC-DC-CONVERTER WITH COUPLED INDUCTOR FOR LOW INPUT VOLTAGES”, Proceedings of PowerMEMS 2008+microEMS 2008, Sendai, Japan, Nov. 9-12, 2008, pp. 145-148. This can, however, not be the case at all operating points according to the wave forms given in this publication. Instead, the curves of the gate control voltage suggest that n-JFET and NMOS are operated intermittently in parallel, and consequently are switched on and off simultaneously. The starting voltage of the circuit is 70 mV.

In the publication “DC-DC-CONVERTER WITH INPUT POLARITY DETECTOR FOR THERMOGENERATORS”, Proceedings PowerMEMS 2009, Washington D.C., USA, Dec. 1-4, 2009, pp. 419-422, the concept from “STEP-UP DC-DC-CONVERTER WITH COUPLED INDUCTOR FOR LOW INPUT VOLTAGES”, Proceedings of PowerMEMS 2008+microEMS 2008, Sendai, Japan, Nov. 9-12, 2008, pp. 145-148, is further develop in such a way that the n-JFET is replaced with a special NMOS transistor with a threshold voltage of 0 V at a channel resistance of 250 ohm. The gate of this transistor is connected to the input voltage via a pn-diode in order to ensure that the circuit starts up at a low input voltage. Via a feedback loop from secondary winding 2 of the transformer, this transistor is coupled capacitively to the feedback path of the oscillator, as is the second NMOS transistor, which, as a power transistor, has a higher threshold voltage and a lower channel resistance.

The functional principle corresponds to the concept from the publication “IEEE TRANSACTIONS ON INDUSTRY APPLICATIONS”, VOL. 33, NO. 5, SEPTEMBER/OCTOBER 1997. At low input voltages, first the Meissner oscillator begins to work and generates an alternating voltage in the second winding 2 of the transformer. As soon as the amplitude of this alternating voltage is large enough, the power transistor becomes active as a switch and generates a lower-loss step-up of the voltage at the output due to its smaller channel resistance. The starting voltage of this circuit is 110 mV.

According to data sheets for two switching circuits from the company Linear Technology with the type designations LTC 3108 and LTC 3109, these ICs likewise use a Meissner oscillator in a modified configuration. In the LTC 3108 data sheet, it can be seen that an NMOS transistor with a channel resistance of 0.5 ohm at a gate voltage of 5 V is connected in series to the primary winding 1 of a transformer at the input voltage. A secondary winding with a higher number of windings is connected to the gate of the transistor via a capacitive feedback, which is arranged in the form of an RC high pass at the gate of the NMOS. A further capacitor at the secondary winding forms, in combination with two Schottky diodes, a capacitive voltage doubler connection and generates an increased and rectified output voltage of up to 5.25 V from the alternating voltage that is generated in the secondary winding. Output voltages greater than 5.25 V are terminated at the output of the converter circuit by means of a Zener diode. The functional principle corresponds to the above-described concept of a Meissner oscillator, with the difference that instead of the JFET an enhancement MOSFET is used and the output voltage is derived capacitively from the same secondary winding as is also used for the feedback of the oscillator circuit. A value of 20 mV is given as the starting voltage for the LTC 3108 IC.

In the publication “ULTRA-LOW INPUT VOLTAGE DC-DC CONVERTER FOR MICRO ENERGY HARVESTING”, Proceedings PowerMEMS 2009, Washington D.C., USA, Dec. 1-4, 2009, pp. 265-268, again a Meissner oscillator with an n-JFET is presented. Here the secondary winding of the transformer is earthed on one side, while the high point is connected directly to the gate of the transistor. The output voltage is acquired from the secondary winding of the transformer both via simple pn-diodes and via voltage doubler connections. The functional principle corresponds to that in the publication “IEEE TRANSACTIONS ON INDUSTRY APPLICATIONS”, VOL. 33, NO. 5, SEPTEMBER/OCTOBER 1997, with the difference that the base point of secondary winding 2 is connected directly to earth. A third winding is not used, contrary to the circuit from “IEEE TRANSACTIONS ON INDUSTRY APPLICATIONS”, VOL. 33, NO. 5, SEPTEMBER/OCTOBER 1997. Instead, the output voltage is acquired from secondary winding 2. Instead of one transformer, however, here a plurality of transformers is used, which are connected in parallel on the primary side and in series on the secondary side. This is used to increase the effective winding ratios between the primary side and the secondary side. Given as the minimal starting voltage is 6 mV.

A serious disadvantage of the two known concepts of the step-up converter and the forward converter according to U. Tietze, Ch. Schenk, “Halbleiter-Schaltungstechnik”, Springer-Verlag, 11th edition, 1999, page 985 is that a minimal control voltage is required for driving the power transistors. This voltage is generated with a control circuit that, on the other hand, places demands on the available operating voltage. The minimum starting voltage of integrated low-voltage step-up converters today is accordingly roughly 0.6 V. With supplementary auxiliary wiring, minimal starting voltages of roughly 0.3 V are achieved. Lower starting voltages are not achieved according to today's state of the art. Forward converters with such low starting voltages are not known as of now. In addition, continuous internal power consumption arises in the control circuit, and this has a disadvantageous effect on the efficiency of the DC conversion.

The disadvantage of the circuit known from “IEEE TRANSACTIONS ON INDUSTRY APPLICATIONS”, VOL, 33, NO. 5, SEPTEMBER/OCTOBER 1997, is that, at low operating voltages, the n-JFET used already draws significant power from the input of the circuit even before the circuit starts, and consequently it can load the connected generator considerably. The reason given for this is that in publication 2, an n-JFET with low channel resistance is used deliberately in order to keep the losses in the transistor low during the oscillator operation. Furthermore, a negative auxiliary voltage is periodically built up and broken down at the RC element of secondary winding 2. Consequently, energy is generated and destroyed continuously, and this energy is consequently no longer available at the output of the circuit. The negative polarity of this auxiliary voltage can moreover not be combined simply with the positive polarity of the system voltage.

To be seen as disadvantageous in the arrangements according to “STEP-UP DC-DC-CONVERTER WITH COUPLED INDUCTOR FOR LOW INPUT VOLTAGES”, Proceedings of PowerMEMS 2008+microEMS 2008, Sendai, Japan, Nov. 9-12, 2008, pp. 145-148, and “DC-DC-CONVERTER WITH INPUT POLARITY DETECTOR FOR THERMOGENERATORS”, Proceedings PowerMEMS 2009, Washington D.C., USA, Dec. 1-4, 2009, pp. 419-422, is, on the other hand, that in the RC element of the corresponding circuit a negative auxiliary voltage is built up that cannot be combined simply with the positive polarity of the system voltage, and consequently cannot be used simply. There are moreover continually energy losses due to the resistance of the RC element. The “regulation loop” uses clamp circuits and diode multipliers as protective wiring for the gate of the power NFET, whereby these destroy energy both during operation and in the event of overload and allow losses to occur in the diodes. The use of the relatively small primary winding of the transformer as the inductor of a step-up converter leads to it being necessary to use power transistors with very low channel resistance and relatively high gate threshold voltage in order to keep the losses of the converter low,

The output voltage of the converter is terminated starting at a value of 5.25 V according to LTC 3108 and LTC 3109, which allows the voltage to be limited to values that are not dangerous, but that simultaneously destroy power unnecessarily. The use of the voltage doubler connection in the output circuit generates internal losses in the corresponding switching diodes.

An important disadvantage of the circuit from “ULTRA-LOW INPUT VOLTAGE DC-DC CONVERTER FOR MICRO ENERGY HARVESTING”, Proceedings PowerMEMS 2009, Washington D.C., USA, Dec. 1-4, 2009, pp. 265-268, consists of the fact that the use of a series-parallel circuit of transformers increases the construction size and manufacturing costs of the circuit considerably. The direct connection of the secondary winding to the circuit earth results in an inexpedient increase in the necessary starting voltage, which here must be compensated for with a very high transformation ratio of the transformer.

The object forming the basis of the present invention is consequently to provide a DC converter circuit which overcomes the disadvantages of the known circuits, that activates at extremely low input voltages, and that works at a high efficiency level.

This object is solved by the object of the independent patent claims. Advantageous further developments of the DC converter according to the invention are objects of the dependent claims.

From the analysis of the state of the art, it follows that a self-oscillating oscillator with internal transformer coupling as a basic circuit of a DC converter with low starting voltage appears to be suitable. It likewise appears expedient to use a junction field-effect transistor (JFET) for starting up the circuit at low input voltages and additionally to use MOSFETs with low channel resistance in order to achieve a step-up of the low input voltage into a higher output voltage that is more efficient in terms of power. In all known converter circuits, however, the arrangement of the MOSFETs and JFETs takes place in parallel and on a single shared input winding of a transformer. The transformer that is used is consequently, in alternation, supplied with power and separated again from the power supply via this one winding. A higher output voltage is acquired from the resulting alternating magnetic field via secondary windings.

The present invention is therefore based on the idea of connecting the JFETs or MOSFETs to separate input windings of a shared transformer. By means of suitable connection of the transformer feedback, it is possible to achieve a supply of power to both input windings in an alternating manner.

In this way, it is possible in principle to realise a forward converter. It is known that this switching converter principle allows greater efficiency than simpler transformer converters. A disadvantage of known forward converters, however, is that the alternating switching on and switching off of the transistors, on the other hand, requires an electronic control circuit that consumes energy continuously. This is avoided in the present invention by means of suitable coupling of the transistors to a shared feedback of the transformer. There consequently results a self-oscillating forward converter that already starts up at low input voltages.

A further advantage of the circuit arrangement according to the invention is the use of all stepped-up voltages from the converter circuit in order to draw maximum energy use from its operation while simultaneously controlling the conversion appropriately. Different methods of active rectification are likewise used in order to minimise internal losses. Here again, on the other hand, all required control voltages are acquired from windings of the transformer using a low technical effort.

For a better understanding of the present invention, it is explained in more detail on the basis of the embodiments depicted in the following figures. Parts that are the same are given the same reference numbers and the same component designations. Furthermore, individual features or combinations of features of the shown and described embodiments can depict independent inventive solutions or solutions according to the invention in themselves.

Shown are:

FIG. 1 a schematic depiction of the DC converter circuit with connected generator and connected load;

FIG. 2 the circuit of an inductive step-up converter according to the state of the art;

FIG. 3 the circuit of an inductive forward converter according to the state of the art;

FIG. 4 the circuit of a Meissner oscillator as a step-up converter according to the state of the art;

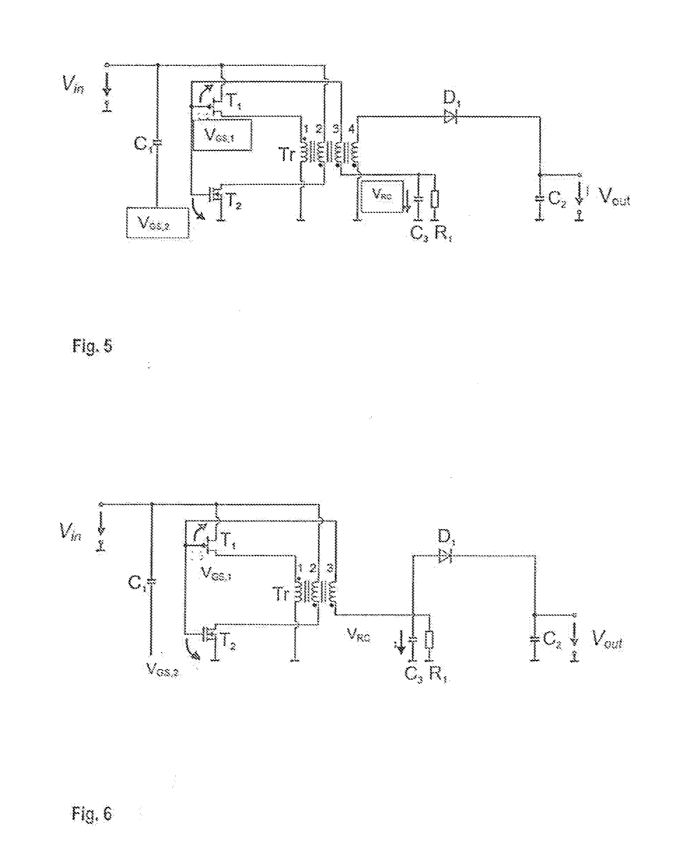

FIG. 5 a first embodiment of the step-up DC converter according to the invention;

FIG. 6 a further embodiment of the step-up DC converter according to the invention;

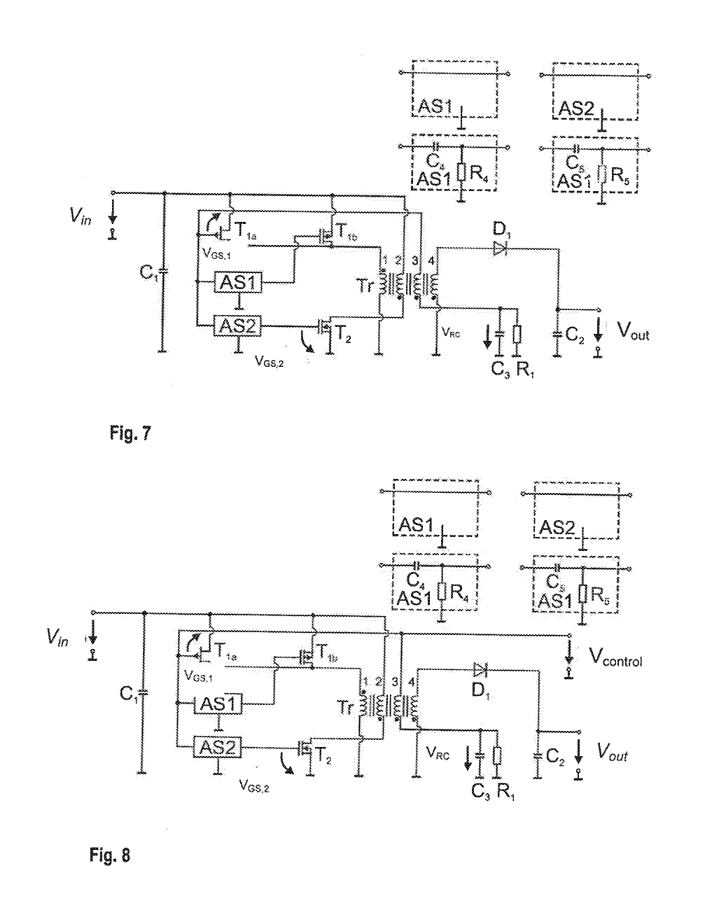

FIG. 7 a further embodiment of the described step-up DC converter with the addition of further transistors;

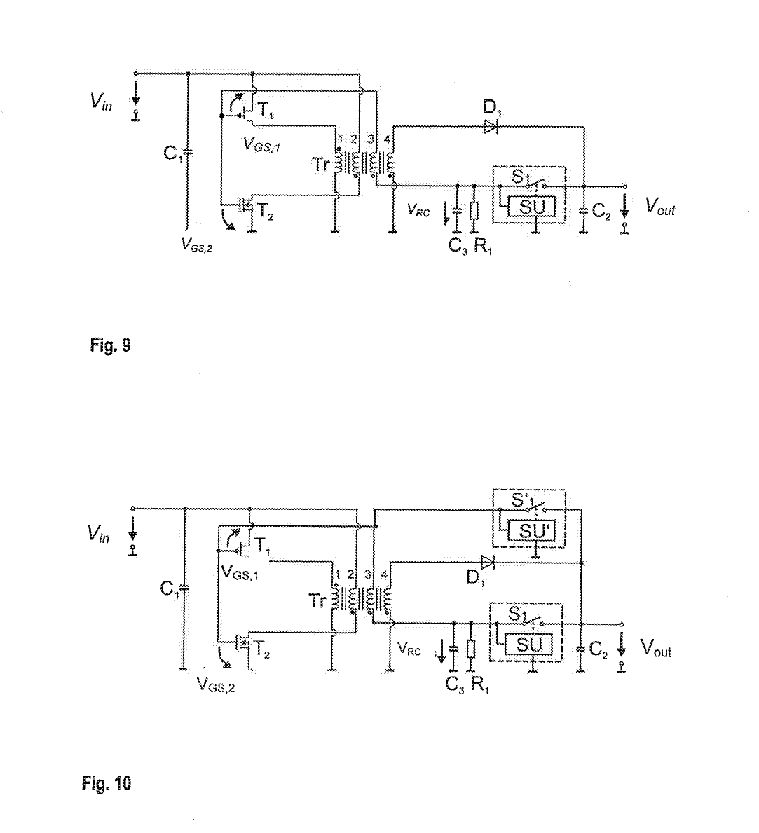

FIG. 8 a modification of the step-up DC converter from FIG. 7, in which a switch-off is possible;

FIG. 9 a further embodiment of the described step-up DC converter with an added dissipation of internally generated energy to the output;

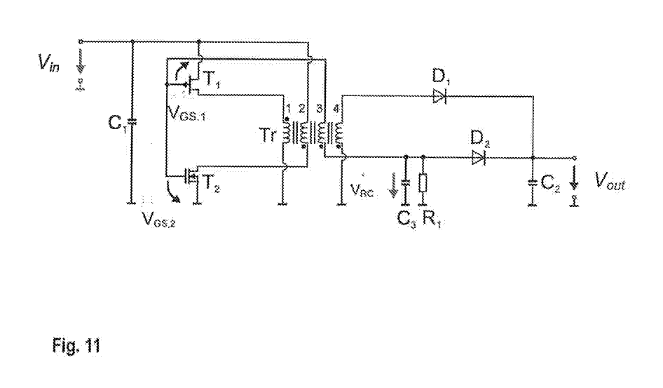

FIG. 10 a modification of the embodiment of FIG. 9;

FIG. 11 a further embodiment of the described step-up DC converter with an added dissipation of internally generated energy to the output;

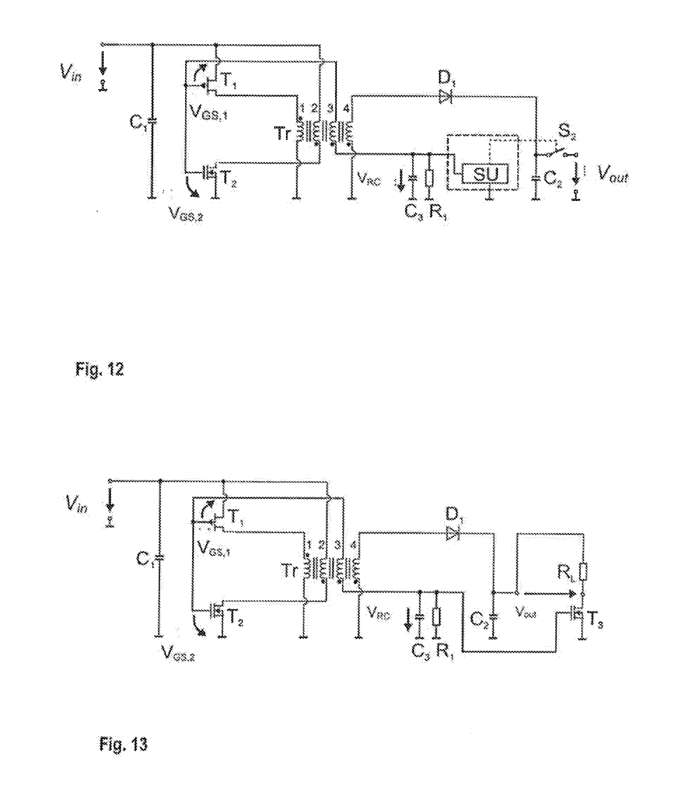

FIG. 12 a further embodiment of the described step-up DC converter with an added, voltage-controlled activation of the load at the output;

FIG. 13 a further embodiment of the described step-up DC converter with an added, voltage-controlled activation of the load at the output;

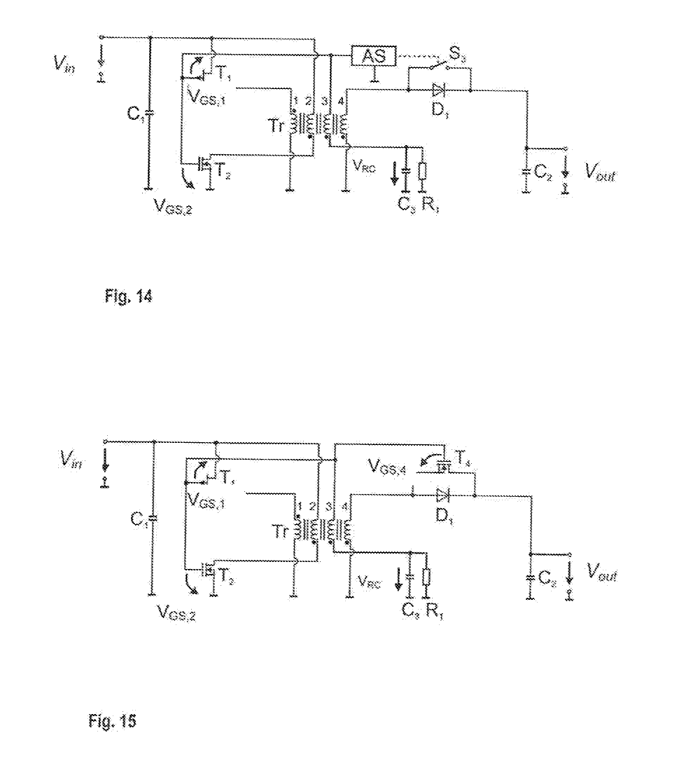

FIG. 14 a further embodiment of the described step-up DC converter with active rectification of the output voltage at winding 4 of the transformer;

FIG. 15 a further embodiment of the described step-up DC converter with active rectification of the output voltage at winding 4 of the transformer;

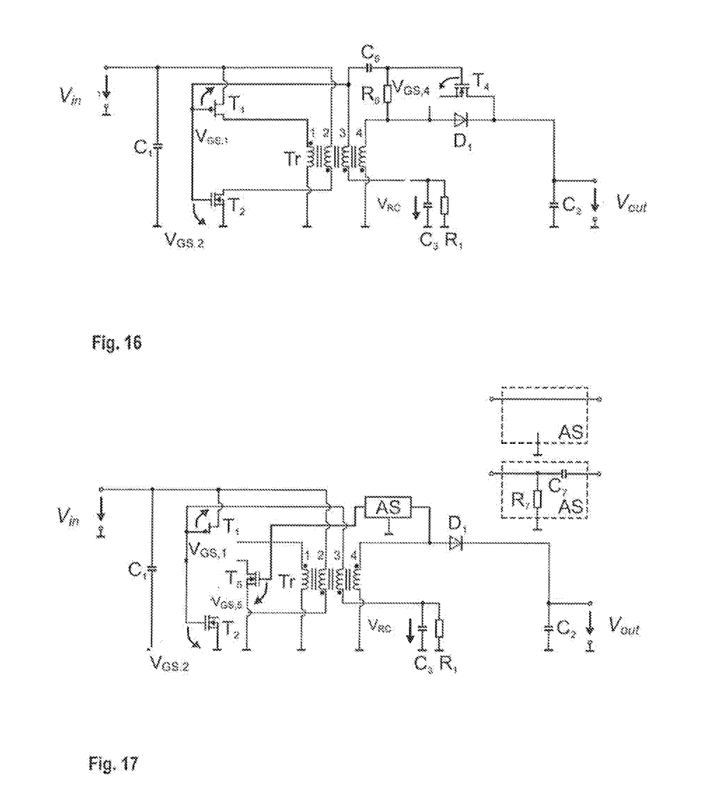

FIG. 16 a further embodiment of the described step-up DC converter with active rectification of the output voltage at winding 4 of the transformer;

FIG. 17 a further embodiment of the described step-up DC converter with active rectification of the voltage at winding 3 of the transformer.

The invention will now be explained in more detail starting with reference to FIG. 5.

FIG. 5 shows, in a first embodiment, the basic concept of a DC converter according to the invention. The circuit comprises two transistors T₁ and T₂, whereby T₁ is executed as a p-channel junction field-effect transistor and T₂ is executed as an n-channel enhancement MOS field-effect transistor. The voltage Vᵢₙ at the input terminals of the circuit lies on a series circuit of transistor T₁ and a primary winding 1 of a transformer Tr. Each of the marking points on the schematically depicted windings of the transformer indicates the beginning of a winding with identical winding sense and is used to place the winding senses of the different windings in relationship to one another. A terminal of a winding provided with a point is called the “high point” in the following, and the second terminal of the winding is called the “base point”.

The series circuit of transistor T₁ and primary winding 1 is formed such that the source terminal of T₁ is connected to the positive pole of the input voltage. The drain terminal of T₁ is connected to the high point of the primary winding 1. The base point of the primary winding 1 is connected to the earth terminal of the input voltage, which simultaneously constitutes the reference potential of the entire circuit.

A second primary winding 2 of the transformer is connected to the drain terminal of transistor T₂ at its high point. The base point of this winding lies on the positive terminal of the input voltage. The source terminal of transistor T₂ is connected to the reference potential.

A secondary winding 3 of the transformer has a greater number of windings than do the primary windings 1 and 2, and is used to feed the induced voltage with appropriate phase shift back to the gate terminals of the respective transistors T₁ and T₂. For this purpose, the base point of secondary winding 3 is connected to the gate terminals of transistors T₁ and T₂. The high point of secondary winding 3 is connected, via a parallel circuit consisting of a capacitor C₃ and a resistor R₁, to the positive pole of the input voltage Vᵢₙ, to the output voltage Vₒᵤₜ or, as shown in FIG. 5, to the reference earth. The connection to Vᵢₙ has the advantage that the circuit starts oscillating more quickly at higher input voltages. At low input voltages, e.g., voltages around 20 mV, this effect is scarcely relevant, however. The connection to Vₒᵤₜ has the advantage that the rectified current flow through the RC element charges the output capacitor C₂ and consequently energy is transferred to the output.

The p-JFET T₁ already has a conductive channel between the source and drain at a gate-source voltage of 0 V. When an input voltage Vᵢₙ is applied, the current through T₁ and the winding 1 of the transformer consequently increases. This does not occur instantaneously due to the inductive behaviour of the winding 1. The resulting temporal change in the input current induces an alternating voltage in the winding 3 of the transformer, whereby this alternating voltage lies between the gate terminals of the transistors T₁ and T₂ and a terminal of the RC element. By means of suitable arrangement of the winding senses of winding 1 to winding 3 with their associated transistors, this alternating voltage is given a phase shift which defines both transistor T₁ as well as transistor T₂ with their associated windings 1 and 2, as a self-oscillating oscillator. At the same time, it is ensured that the windings 1 and 2 are energised in alternation, i.e., due to the voltage of winding 3 that is fed back, transistors T₁ and T₂ are switched by the same signal in alternation from the conductive to the blocking state. The amplitude of the alternating voltage on winding 3 is determined by the transformation relationships between windings 1, 2 and 3 and by the input alternating voltage on winding 1 and winding 2.

When a particular minimum value of the input voltage Vᵢₙ is applied, which is referred to in the following as “starting voltage”, first the Meissner oscillator begins oscillating with T₁. The increase in the voltage between the high point and the earth point of winding 1 in the positive direction leads to the generation of a voltage between the high point and the earth point of winding 3 in the negative direction. This voltage, which increases in the negative direction, at winding 3 lies between the gate terminal of transistor T₁ and the RC element, which is, for example, connected to earth.

The channel current through the p-JFET T₁ decreases as soon as the voltage between its gate and the source terminal increases in the direction of positive values. At a certain threshold voltage, the channel current comes to a stop. On the other hand, the channel current increases as soon as the voltage between its gate and the source terminal increases in the direction of negative values. The diode begins to conduct between the source and gate at a gate source voltage of roughly −0.6 V. As a result, a further increase in the gate-source voltage in the direction of greater negative values is prevented. The gate-source voltage is now limited by the increasing branch of the current-voltage characteristic curve of the gate-source diode.

At input voltages Vᵢₙ above the starting voltage, the above-described behaviour generates an operation of the combination of transistor T₁ and transformer as a Meissner oscillator. Because only small changes occur in the gate-source voltage of T₁ around 0 V, transistor T₁ remains continuously conductive, whereby its channel resistance is, however, changed, corresponding to the gate-source voltage. With a further increase in the input voltage Vᵢₙ the amplitude of the alternating voltage at winding 3 reaches levels that lie above the terminal voltage of the gate-source diode of T₁. Now the gate-source diode of T₁ limits, as described, the further increase of the voltage at the gate in the negative direction, but not the increase in the positive direction. The alternating voltage at winding 3 is likewise now rectified by the diode effect of the gate-source path of T₁. In this way, the capacitor of the RC element charges in the direction of positive voltage values, i.e., V_{RC} increases. This direct voltage shifts the working point of the gate-source voltage V_{GS} in the direction of positive values. In this way, the p-JFET T₁ now switches on and off completely during an oscillation period, i.e., its channel resistance changes abruptly from small to very large values. This further increases the amplitude of the alternating voltage at winding 3 in the sense of positive feedback, because now the greater variation in the channel resistance causes the temporal variation of the current through the primary winding 1 to increase. Furthermore, the direct voltage portion of the voltage at the gate terminals of T₁ and T₂ increases, because the capacitor of the RC element is charged to higher direct voltage values.

At a further, higher value of the input voltage Vᵢₙ, transistor T₂ also begins to work in oscillator mode, because now the sum of V_{RC} and the amplitude of the alternating voltage at winding 3 generates a voltage signal that switches transistor T₂ on and off in alternation. This value of Vᵢₙ, is called the “switching voltage” in the following.

Now a periodically clocked input current also flows through winding 2 of the transformer. The winding sense of winding 2 is designed with the sense opposite to that of winding 1 and the same as that of winding 3. This combination of windings forms a second Meissner oscillator, which starts oscillating in conjunction with the first Meissner oscillator and works in a push-pull manner with it. The entire connection of transistors T₁ and T₂ to the transformer forms, as a result, a single-ended forward converter in resonant feedback. At the gate of the two transistors there arises an alternating voltage, whose extreme values lie between the terminal voltage of the p-JFET T₁ at roughly −0.6 V and a positive value above the threshold voltage of transistor T₂. As a result, transistors T₁ and T₂ work in a push-pull manner, i.e., they are conductive in alternation. Transistor T₁ now acts as an actively switched diode of the forward converter, while T₂ constitutes the actual switching transistor.

In principle, the feedback winding 3 of the transformer can already be used in order to supply an increased alternating voltage at the output Vₒᵤₜ of the circuit from the varying magnetic field in the core of the transformer. A plurality of embodiments for this purpose is described in the following. A further winding 4 of the transformer is used, as needed, in order, on the other hand, to acquire an increased alternating voltage from the varying magnetic field in the core of the transformer, whereby this alternating voltage is conducted to the output Vₒᵤₜ of the circuit. It shall likewise be understood that two different output terminals with different output voltages can be generated with the alternating voltages from winding 3 and winding 4. The transformation relationship, on the other hand, can be selected by the winding relationship between windings 1, 2, 3 and 4, and the polarity of the output voltage can be selected by the winding sense. FIG. 5 depicts an embodiment in which the winding directions of winding 3 and winding 4 are designed such that the alternating voltages at the two windings occur with a phase offset of zero degrees. Likewise, if needed, the winding sense of winding 4 can be arranged with respect to winding 3 such that a phase angle of 180 degrees occurs. These alternating voltages at winding 3 and winding 4 can be rectified with known concepts of voltage rectification, e.g., with the half-wave rectifier shown in FIG. 4 or, e.g., with the full-wave rectifier shown in FIG. 3. Active rectification is also possible, as is explained in the following in a further embodiment. The rectified voltage is smoothed with a backup capacitor C₂ and is used as the output voltage Vₒᵤₜ of the circuit. Likewise, however, the electrical power acquired at the RC element can already be sufficient in order to supply a consumer at the shared output terminals Vₒᵤₜ or on the other hand at a separate output. In the following, a number of circuit variants are explained that make it possible to dissipate energy from the RC element to the output of the circuit. In this case, winding 4 could also be eliminated. The advantage would be that in this way, a transformer with a more compact design could be used.

In the design shown in FIG. 4, the resistor R₁ acts as a load and discharging path for C₃. It is required, because if R₁ is missing, the voltage V_{RC} can increase to positive values which are unfavourable for maintaining the oscillation or which even prevent this oscillation. As V_{RC} gradually increases, the direct voltage portion of V_{GS} grows. The alternating voltage induced in winding 3 is consequently overlaid with a higher and higher direct voltage portion. This can cause transistor T₁ to switch off permanently because the sum of the direct voltage and alternating voltage at its gate becomes too high. Likewise, transistor T₂, if its gate potential is coupled directly to winding 3, can remain continuously conductive, because the voltage at its gate now lies permanently at or above its threshold voltage. As a result, the oscillation amplitude is gradually reduced as V_{RC} rises, or, in the extreme case, the oscillation is even completely suppressed.

The use of R₁ is required in the basic design shown in FIG. 4. In further embodiments of this printed patent specification, capacitor C₃ is loaded othenivise. In these embodiments, R₁ can be increased accordingly, or it can be eliminated completely.

An advantageous characteristic of this circuit lies in the fact that transistor T₂, as a MOSFET, has a lower channel resistance than does the J-FET T₁. Consequently, as soon as the oscillation of transistor T₂ starts, a higher alternating current is applied in the transformer via winding 2 than via winding 1 and T₁. The amplitude of the total voltage induced in winding 3 is consequently increased. This leads to the operation as a forward converter also being maintained when the input voltage Vᵢₙ drops below the switching value that is required for the start of the oscillation of T₂. The operation as a forward converter consequently is maintained for low and variable input voltages.

The preceding basic circuit described with reference to FIG. 5 uses a second secondary winding 4 for the output of the output voltage Vₒᵤₜ, but this second secondary winding is not required in every case. Shown in FIG. 6 is an alternative basic circuit in which diode D1 is connected to the high point of the first secondary winding 3. A further secondary winding 4 can then be eliminated.

The basic circuit described in the preceding with reference to FIGS. 5 and 6 can furthermore be improved with a plurality of additions, which are described in the following:

Parallel connection of a plurality of JFET transistors T₁: a characteristic of JFET transistors lies in the fact that transistors with low amounts of blocking voltage simultaneously have a higher channel resistance. In the present circuit, it is desirable for T₁ to achieve a low blocking voltage and a low channel resistance at the same time. This can be achieved by connecting a plurality of p-JFET transistors of the same or different type to one another in parallel. The parallel connection of these transistors in this way recreates a transistor with the desired characteristics.

Parallel connection of JFET and MOSFET transistors T1a and T1b and the use of trigger circuits: Likewise, as shown in FIG. 7, one or more p-MOSFET transistors T_{1b} can be connected in parallel with the p-JFET transistors T₁ₐ in order to reduce further the total resistance of this combination. For this purpose, the drain, source and gate of transistors T₁ₐ and T_{1b} are each connected to the others. Depending on the arrangement of the trigger circuit AS1 shown in FIG. 7, it is necessary to use a MOSFET T_{1b} that has a threshold voltage that has polarity and a level such that T₁ₐ and T_{1b} switch on and off simultaneously.

FIG. 7 additionally shows that the activation signals for the MOSFETs T_{1b} and T₂ can be acquired, via a trigger circuit AS1 and AS2, from the voltage V_{GS,1}. As already shown in FIGS. 5 and 6, AS1 and AS2 are, in the simplest case, thoughplatings. Active circuits can also be used for the pulse shaping. Likewise, passive circuits can be used for the pulse shaping, such as, e.g., the high pass circuits with R₄ and C₄ and R₅ and C₅ shown in FIG. 7. Likewise, a shared high pass circuit can be used for transistors T₁ₐ and T₂. These high pass circuits are used for pulse shaping and for the elimination of the direct voltage portion of V_{GS,1}. In particular, when these are used, both MOSFETS are switched on and blocked more swiftly and in a more defined manner, because the differentiating effect of the high pass allows the flanks of the alternating voltage that is fed back to pass with preference and at the same time eliminates the direct voltage portion of the alternating voltage that is fed back. In this way, it is possible to reduce switching losses in the transistors and ensure reliable on and off switching. Likewise, now a MOSFET T_{1b} can be used that has a negative threshold voltage V_{GS} that, in terms of the amount, is greater than the negative terminal voltage of the JFET T₁ₐ. The circuit earth, as shown, can be used as a reference potential for these trigger circuits AS1 and AS2, as can, however, likewise the input voltage Vᵢₙ or the output voltage Vₒᵤₜ. This allows the direct voltage portion of the gate-source voltages to be selected suitably.

Furthermore, an additional control input can be provided for the circuit arrangements as shown in FIG. 7, as is shown in FIG. 8. Here a control voltage V_{control} is applied at the base point of the first secondary winding 3, whereby this control voltage comes from a source with sufficiently low internal resistance that can be used to shut down the entire depicted converter circuit as needed. This function can be required if the present converter circuit is operated only as a starter circuit for an additional DC converter circuit, but not for continuous operation. The control voltage V_{control} must then be large enough to block the JFET T₁ₐ permanently. A high pass function of trigger circuits AS1 and AS2 simultaneously ensures that now neither T_{1b} nor T₂ is provided with gate-source voltages that allow a periodic switching on and switching off of these transistors. The oscillation of the entire circuit is interrupted in this way.

Use of the direct voltage at the RC element of the DC converter: The RC element at secondary winding 3 charges to a positive direct voltage V_{RC} in the circuit configuration shown here. Because it is present in the same polarity as the output voltage Vₒᵤₜ, this direct voltage can be used simply for the operation of a load. The RC element can likewise be connected, as a connecting element, between the high point of winding 3 and the output voltage Vₒᵤₜ. It must only be ensured that this use does not impair the adjustment of the working point of the oscillator circuit, This can be accomplished by the use of appropriate voltage monitoring circuits. Further embodiments are depicted schematically in FIGS. 9 to 11 by way of example.

FIG. 9 depicts schematically an embodiment with an active voltage monitoring circuit SU. For this circuit block, which is not discussed here in detail, a circuit with an integrated or discrete configuration can be used. The voltage monitoring circuit SU monitors the level of the voltage V_{RC} continuously. It is also possible to supply it with energy from this voltage. At a certain adjustable threshold value of V_{RC} the schematically depicted switch S₁ is closed, so that a charge can flow from C₃ to the output capacitor C₂. As a result, C₃ is discharged, i.e., V_{RC} drops. It is expedient to provide this switching point with hysteresis in order to obtain an opening of the switch at a lower threshold voltage. This prevents a rapid change in the on and off states of the switch S₁ in the event of a slight oscillation of V_{RC}.

In any case, it is necessary not to close the switch S₁ until a certain level of the voltage V_{RC} is reached. The working point, and consequently the oscillatory characteristics and the starting behaviour of the entire circuit, are adjusted with the level of V_{RC}, i.e., it is necessary to keep the level of V_{RC} in an optimal range. This can be done advantageously with the circuit depicted in FIG. 9, whereby at the same time, excess charging is dissipated from C₃ to the output of the circuit.

Additionally or alternatively, a further voltage monitoring circuit SU′ with a switch S₁′ can be connected to the base point of secondary winding 3, as is shown in FIG. 10.

Likewise, in the circuit shown in FIG. 9, the charge can flow from the output capacitor C₂ to C₃ and consequently change the working point of the oscillator. This effect can by all means be desired in order, e.g., to achieve a regulation of the output voltage Vₒᵤₜ. An increase in V_{RC} due to the inflow of a charge from Vₒᵤₜ will increase the mean gate voltage V_{GS} from the steady state. This will then worsen the efficiency of the step-up if transistors T₁ no longer switch on or transistors T₂ no longer switch off. This effect has already been described. As a result, Vₒᵤₜ drops, as does V_{RC}. As a result, it can consequently be desirable to use a switch S₁ that allows either a current flow in both directions in order to allow the described closed-loop control mechanism, or only a current flow from C₃ to C₂ in order only to dissipate an excess charge from C₃.

The use of the voltage V_{RC}, as depicted in FIG. 11 by way of example, can likewise take place with the help of a diode D₂ that is inserted between V_{RC} and Vₒᵤₜ. The anode of D₂ thereby lies at V_{RC}, and the cathode at Vₒᵤₜ.

This embodiment has the advantage that a charge from C₃ is not dissipated to a considerable degree until the difference between the voltages V_{RC} and Vₒᵤₜ reaches the breakdown voltage of diode D₂. A charge flowing from capacitor C₂ to C₃ is likewise prevented. This circuit variant is consequently suitable for dissipating an excess charge from C₃ to the output with a simple expansion of the basic concept. Disadvantageous is that the dropping voltage at diode D₂ leads to losses. This voltage drop should be kept as small as possible, e.g., by means of the use of germanium diodes or Schottky diodes.

Activation of the load only after the oscillator has built up oscillation: The resistive load at the output of the circuit loads the oscillator while it is building up oscillation. As a result, there is a requirement for a higher starting voltage Vᵢₙ. It is therefore expedient not to switch on the load at the output voltage Vₒᵤₜ until the voltage conversion has started reliably. The voltage V_{RC} can be used as an indicator for this V_{RC} climbs from very low levels to considerably higher levels as soon as the oscillator has built up oscillation completely. FIG. 12 and FIG. 13 show two embodiments in this regard.

In FIG. 12, a voltage monitoring circuit SU monitors the direct voltage V_{RC} at the RC element of the oscillator continually V_{RC} does not exceed significant levels until the rectification of the alternating voltage at winding 3 starts across the gate/source path from T₁. After a certain threshold value has been exceeded, T₂ is additionally switched on and switched off in alternation. The circuit now begins to work as a forward converter and now carries out the step-up with considerably greater efficiency. The corresponding rise in V_{RC} can be detected as an indicator for the entry into this operating mode and used for the activation of the load. The voltage monitoring circuit SU detects that an adjustable voltage threshold (“switch-on level”) of V_{RC} has been exceeded and thereupon closes the switch S₂ in the output circuit. It is expedient to provide the monitoring circuit SU with hysteresis, i.e., the switch S₂ is not opened again until V_{RC} has dropped to a switch-off level that is lower than the switch-on level. In this way, it can be ensured as a whole that the circuit is loaded at the output only if the oscillator is working as a forward converter. Likewise, an undesired, short-term change between a switching-on and separation of the load is prevented by internal hysteresis of the monitoring circuit SU.

FIG. 13 shows a further embodiment. Here an n-channel enhancement MOSFET T₃ uses the voltage V_{RC} as gate-source control voltage in order to switch on the load R_{L} or to disconnect it from the output of the circuit again. The threshold voltage of the transistor must be selected in such a manner that the switching on does not occur until forward converter mode has been entered. The advantage of this embodiment is its simplicity. A disadvantage can be seen in that transistor T₃ switches on or switches off gradually, not abruptly, in the event of a slow transition of V_{RC} through the range of its threshold voltage. This can be prevented by generating the control signal for T₃ by means of a voltage monitoring circuit SU with hysteresis.

Active rectification of the output voltage at winding 4: The alternating voltage at winding 3 can additionally be used in order to close a switch S₃ during the peak level phase of the voltage at winding 4, and consequently to carry out active rectification of the voltage at winding 4. As a result, losses in diode D₁ are reduced, and the output voltage Vₒᵤₜ is increased. The activation of the switch S₃ takes place via a trigger circuit AS, which can be present, e.g., in the form of an integrated circuit or which can be created from passive and active components in a discrete construction. Advantageous in the present embodiment is that the activation signal for switch S₃ can be generated via the trigger circuit AS directly from the alternating voltage at winding 3. For this purpose, a phase shift of 0° or 180° can be generated in the two alternating voltages as needed by means of the adjustment of the winding senses and the connection plan for windings 3 and 4. FIG. 14 shows an embodiment in which the alternating voltages at the two base points of windings 3 and 4 are withdrawn with the same phase position, and consequently a phase angle of 0°.

The trigger circuit AS detects the positive maximum value of the alternating voltage at winding 3 and closes switch S₃ during this time period. Switch S₃ bridges diode D₁ in order to charge capacitor C₂ to the maximum positive value of the phase-locked alternating voltage at winding 4.

Two embodiments of this configuration with a trigger circuit AS in a discrete construction are shown in FIGS. 15 and 16. In both cases, used as switch S₃ is an n-channel enhancement MOSFET T₄. This transistor is mounted in such a manner that its drain terminal is connected to the anode of diode D₁, its source terminal is connected to the cathode of D₁ and its gate terminal is connected to the base point of winding 3, either directly, see FIG. 15, or via a high pass, see FIG. 16.

The embodiment according to FIG. 15 assumes that the maximum positive value of the alternating voltage at winding 3 is greater than the maximum positive value of the alternating voltage at winding 4 by at least the threshold voltage of T₄. This can be achieved by the adjustment of the winding relationships of windings 3 and 4. The amplitude of the alternating voltage at winding 4 also falls as soon as this is loaded, which is advantageous for the abovementioned requirement. The duty cycle of T₄ is determined in this design by the period of time in which the voltage difference between winding 3 and 4 results in a positive voltage V_{GS,4} which lies above the threshold voltage of transistor T₄. This can be disadvantageous, because, e.g., in the case of sinusoidal alternating voltages at windings 3 and 4, the maximum value of the alternating voltage at winding 4 is already exceeded when transistor T₄ switches off again. Capacitor C₂ would consequently not be charged to the maximum value of the alternating voltage at winding 4.

In an improved embodiment according to FIG. 16, a high pass of R₆ and C₆ is used as the trigger circuit AS in order to convert the rising flank of the alternating voltage at the base point of winding 3 into a short positive trigger pulse V_{GS,4} at the gate of transistor T₄. The time constant T of this high pass is calculated, as is known, according to the equation (2):

T=R₆·C₆ (2)

T is a measure of the duration of the current flow through R₆ which occurs after a rapid rise in the alternating voltage at winding 3. This current flow generates, as the voltage drop at R₆, the gate-source voltage V_{GS,4} in a pulse form and consequently defines the duty cycle of transistor T₄. By means of suitable adjustment of T, it can be ensured that transistor T₄ switches on with the quickly rising flank of the alternating voltage at winding 3 and switches off again shortly after the maximum value of the voltage at winding 4 has been run through. In this way, capacitor C₂ is charged to this maximum value, as desired.

Active rectification of the feedback voltage from winding 3 at the gate of transistor T₁: The gate-source path of transistor T₁ terminates the voltage at the base point of winding 3 to values around roughly −0.6 V due to its diode effect. This diode can be bridged in the sense of active rectification by activating a transistor T₅ at the gate terminal of T₁. As a result, losses in the gate-source diode are reduced, and the alternating voltage at winding 3 is shifted upwards by the amount of the terminal voltage of the diode. Both effects increase the efficiency of the DC converter.

In the embodiment shown in FIG. 17, an n-channel enhancement MOSFET is used as transistor T₅. The drain terminal of T₅ lies at the gate terminal of T₁, the source terminal can be connected either, as depicted in FIG. 14, to earth or to the positive pole of the input voltage Vᵢₙ. With this circuitry, the source-substrate diode of T₅ lies parallel to the gate-source diode of T₁, i.e., the starting behaviour of the Meissner oscillator with T₁ is not adversely influenced.

The gate-source voltage V_{GS,5} of T₅ can be dissipated directly from the output voltage to winding 4. For this, for example, the winding sense of winding 4 is fashioned such that the alternating voltage at the high point of winding 4 lies at the base point of winding 3 with a 180° phase shift to the voltage V_{GS,1} . The connection of the gate electrode and winding 4 is handled in turn with a trigger circuit AS. In the simplest case, this is a direct connection, alternatively it is a combination of passive and/or active electrical elements for pulse shaping, e.g., the high pass of C₇ and R₇ depicted in FIG. 14. Consequently, T₅ always switches on when the feedback coupling voltage at winding 3 reaches a negative value, meaning without T₅ being terminated by the JFET T₁. Alternatively, an active electronic circuit AS can be used for the generation of V_{GS,5}. This active circuit can likewise manufacture an appropriate phase shift of V_{GS,5} and V_{GS,1}. In this case, the winding sense of windings 3 and 4 can be selected freely.

1. DC converter circuit for the generation of an output voltage from an input voltage (Vᵢₙ), comprising:
a transformer (Tr) with a first primary winding (1), which can be connected to the input voltage (Vᵢₙ) via a first transistor (T₁) that is connected in series, and a second primary winding (2), which can be connected to the input voltage (Vᵢₙ) via a second transistor (T₂) that is connected in series,
wherein the transformer (Tr) furthermore has at least one secondary winding (3, 4) that has a larger number of windings than the first and the second primary winding (1, 2), and that is connected to the control inputs of the first and second transistor (T₁, T₂) as well as to an output terminal of the DC converter circuit for the output of the output voltage (Vₒᵤₜ).

2. DC converter circuit according to claim 1, wherein the transformer (Tr) has a first secondary winding (3) that is connected to the control inputs of the first and second transistor (T₁, T₂) and a second secondary winding (4) that is connected to the output terminal of the DC converter circuit for the output of the output voltage (Vₒᵤₜ).

3. DC converter circuit according to claim 2, wherein the winding sense of the second primary winding (2) is opposite to the winding sense of the first primary winding (1) and in the same direction as the winding sense of the first secondary winding (3).

4. DC converter circuit according to claim 2 or 3, wherein the winding sense of the second secondary winding (4) is in the same direction as the winding sense of the first secondary winding (3).

5. DC converter circuit according to one of the preceding claims, wherein the first transistor (T₁) comprises at least one junction field-effect transistor (JFET) and the second transistor (T₂) comprises a field-effect transistor with isolated gate (MOSFET).

6. DC converter circuit according to one of the preceding claims, wherein an RC circuit (R₁, C₃) is arranged in series with the at least one secondary winding (3).

7. DC converter circuit according to claim 6, wherein the RC circuit (R₁, C₃) is connected to the output terminal of the DC converter circuit.

8. erter circuit according to claim 7, wherein the RC circuit (R₁, C₃) is connected to the output terminal via a voltage monitoring circuit (SU) or a diode (D₂).

9. DC converter circuit according to one of the claims 1 to 5, wherein an RC circuit (R₁, C₃) is arranged between the at least one secondary winding (3) and the output terminal.

10. DC converter circuit according to one of the preceding claims, wherein a controllable switch (SU, S₁; T₃) is provided in an output circuit of the circuit, and wherein this controllable switch can be operated to apply the output voltage (Vₒᵤₜ) to an electrical load R_{L} only after a predetermined transient state has been reached.

11. Converter circuit according to claims 6 and 10, wherein the predetermined transient state has been reached when a voltage drop at the RC circuit (R₁, C₃) has exceeded a predetermined threshold value.

12. DC converter circuit according to one of the preceding claims, wherein furthermore an active rectifier circuit (AS, S₃; T₄) is connected to the output terminal.

13. DC converter circuit according to one of the preceding claims, wherein furthermore a third transistor (T₅) is arranged at the control input of the first transistor (T₁) in order to bridge a gate-source path of the transistor (T₁) for active rectification.
